(19) United States
(12) Patent Application Publication
(10) Pub. No.: US 2009/0242657 A1
(43) Pub. Date: Oct. 1, 2009

(54) Systems And Methods For Automatically Varying Droplet Size In Spray Released From A Nozzle

(75) Inventor: John Peterson, Jackson, MN (US)

Correspondence Address: TROUTMAN SANDERS LLP;BANK OF AMERICA PLAZA, 600 PEACHTREE STREET, N.E., SUITE 5200, ATLANTA, GA, 30308-2216, US

(73) Assignee: AGCO Corporation, Duluth, GA (US)

(21) Appl. No.: 12/056,408

(22) Filed: Mar. 27, 2008

(51) Int. Cl. B05B 17/04; B05B 12/12

(52) U.S. Cl. 239/11; 239/74; 239/159

(57) ABSTRACT

Systems and methods are provided for spraying chemicals and automatically adjusting, in substantially real-time, the drop size of the liquid in the spray. The drop size may be adjusted to control (either minimize or maximize) the amount of drift associated with the sprayed liquid.

### BACKGROUND OF THE INVENTION

1. Field of the Invention

The present invention relates generally to systems and methods for spraying pesticides and other chemicals and, more particularly, to systems and methods that automatically vary the size of droplets released from a nozzle in substantially real-time to control drift associated with spraying pesticides and other chemicals.

2. Description of Related Art

Pesticide or chemical drift is usually discussed in reference to vapor drift and particle drift. Vapor drift involves the evaporation of a pesticide from the soil or crop surface that occurs after application. The vapors are carried by the wind (drift) and then settle on unintended targets. Vapor drift does not depend on the machinery employed to spray the pesticide. Particle or physical drift (sometimes referred to as spray drift) occurs when small drops of sprayed pesticide get carried by the wind and land on unintended targets. Particle drift increases as wind speed increases.

Particle drift, unlike vapor drift can be directly affected by the spray equipment employed (e.g., the type of nozzle). A nozzle has essentially two functions: to meter the amount of liquid that can be sprayed and to create a spray pattern. In an effort to minimize drift, nozzles have been designed to optimize the size of the drop that is sprayed from the nozzle. Two such nozzle types are pre-orifice and turbulation type nozzles. In the pre-orifice nozzle, the two functions (volume and pattern) are separated between two orifices. The first orifice controls the flow into the nozzle and the second orifice controls the spray pattern. This reduces pressure on the liquid as it exits the nozzle resulting in larger drops and thus less drift. In the turbulation type nozzle, a chamber is provided which provides room for the liquid to expand prior to exiting the nozzle. This lowers the pressure behind the liquid that exits the nozzle, thus creating larger drops and less drift.

One type of pre-orifice nozzle is an air-atomizing nozzle. This is a nozzle that draws air into the liquid through a carburetor-like venture. The air and liquid pass through a mixing chamber and are sprayed out together. By introducing air, the nozzle is capable of producing larger drops, which results in less drift. These advancements in nozzle technology have provided the ability to manually adjust the drop size in substantially real time.

In view of the foregoing, it would be advantageous to provide a system for spraying pesticides and other chemicals in such a way that the drop size of the sprayed liquid can be automatically changed in substantially real-time. It would also be advantageous to automatically optimize the drop size in substantially real-time.

### BRIEF SUMMARY OF THE INVENTION

Embodiments of the present invention provide systems and methods for spraying chemicals such as pesticides. Some embodiments provide substantial real-time adjustment of the drop size of the sprayed liquid. Some embodiments optimize the drop size to minimize drift. Some embodiments optimize the drop size for other reasons such as amount of chemical needed in a particular area, or to maximize the area of spray, or possibly even to maximize the amount of drift.

An aspect of the invention provides a system for dispersing a liquid and for automatically changing a drop size of the liquid being dispersed in substantially real-time. The system includes a spraying device having at least one nozzle for dispersing liquid. The system also includes a nozzle control device in communication with the nozzle. The nozzle control device is configured to alter a drop size of the dispersed liquid in response to receipt of a control signal. The system includes at least one processor in electrical communication with the nozzle control device which is configured to provide the control signal. The system also includes multiple sensors which are in electrical communication with the processor. The sensors are configured to provide input to the processor about various conditions that could affect drift associated with the sprayed liquid. The control signal is based at least in part on the input from the sensors.

Another aspect of the invention provides a system for dispersing a liquid and for automatically changing a drop size of the liquid being dispersed in substantially real-time. The system includes a spray module configured to disperse liquid through a nozzle, a control module configured to control a drop size of the dispersed liquid in response to receipt of a control signal, a sensor module configured to measure atmospheric conditions and a processor module configured to process the atmospheric conditions, determine a desired drop size based upon the measured atmospheric conditions, compare the desired drop size to the actual drop size and create the control signal to adjust the actual drop size to the desired drop size.

Embodiments of the invention include a method for dispersing a liquid and for automatically changing a drop size of the liquid being dispersed in substantially real-time. The method includes measuring with a sensor at least one atmospheric condition and based at least in part on that measurement, calculating with a processor a desired drop size and comparing the calculated drop size with an actual drop size of a liquid being dispersed through a nozzle. The method also includes determining that the calculated drop size and the actual drop size differ and in response to such a determination creating a control signal with the processor. The method also includes sending the control signal to a nozzle control and the nozzle control adjusting the actual drop size to equal the desired drop size to create a new actual drop size.

The invention will next be described in connection with certain illustrated embodiments; however, it should be clear to those skilled in the art that various modifications, additions and subtractions can be made without departing from the spirit or scope of the claims.

### BRIEF DESCRIPTION OF THE DRAWINGS

For a better understanding of the present invention, reference is made to the following description, taken in conjunction with the accompanying drawings, in which like reference characters refer to like parts throughout, and in which:

FIG. 1 is a block diagram of a system for spraying chemicals in which a drop size of the chemical may be adjusted in substantially real-time in accordance with an embodiment of the present invention; and,

FIG. 2 is a flowchart of illustrative stages involved in the adjustment of the drop size in accordance with embodiments of the present invention.

### DETAILED DESCRIPTION OF THE PREFERRED EMBODIMENTS

Embodiments of the present invention relate to systems and methods for spraying chemicals and automatically adjusting, in substantially real-time, the drop size of the liquid in the spray. While the invention is especially useful for spraying harmful pesticides it is equally applicable to many other chemical spray applications, e.g. fertilizer, paint, etc. For ease of explanation the remainder of the description shall be limited to pesticides. Those skilled in the art will recognize, however, that the description could be applied to other types of chemicals as well. Also, due to the cost of the system it is particularly useful for large boom type applicators, but it is equally applicable to any system that is employed to disperse chemicals.

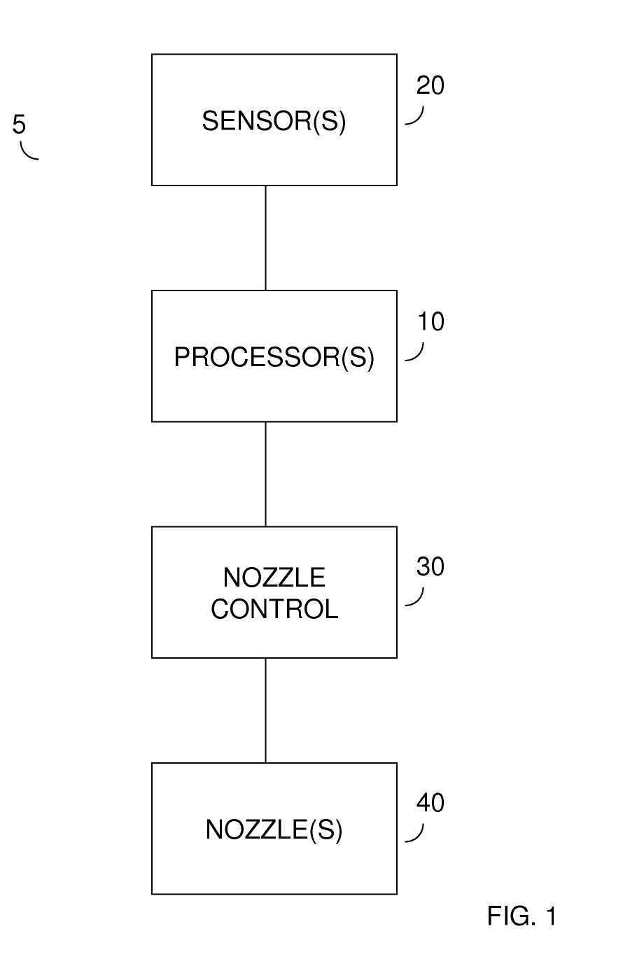

FIG. 1 is a block diagram of a system 5 for spraying chemicals and automatically adjusting, in substantially real-time, the drop size of the liquid in the spray in accordance with an aspect of the invention. System 5 includes processor(s) 10, sensor(s) 20, nozzle control 30 and nozzle(s) 40 that communicate with one another as necessary. Each of processor(s) 10, sensor(s) 20, nozzle control 30 and nozzle(s) 40 may be in direct electrical communication with each other via a suitable communications capability such as a cable or optical connection or one or more of these devices may be in communication with each other via a wireless connection. While it is preferable that each of the processor(s) and sensor(s) is directly attached to the device that is being employed to spray the liquid, it is also within the scope of the present invention that one or more of the processor(s) and/or sensor(s) is/are located separate from the device. In the event that an element is separate from the spray device, that separate device will communicate with the device through a satellite connection, a local area network (“LAN”), a wide area network (“WAN”) or any other suitable wired, wireless, or optical connection, or a combination thereof.

A multitude of sensors 20 exist, any combination of which could be employed along with one or more processors 10 and a sprayer to achieve a device in accordance with the present invention. For example, global position systems exist that could be employed to provide both latitude and longitude and topographical maps. To the extent that a topographical map does not exist or is insufficient, or simply for redundancy purposes, radar could be employed to provide additional topographical feedback (including but not limited to crop height, animal concentration, physical hazards such as fences, wall, ditches, etc.). Other sensors 20 that measure humidity, wind speed, wind direction, temperature, flow speed and vehicle speed could be employed to assist in the determination of the optimal drop size. While the previous description of the sensors indicates discrete sensors for each factor, it will be apparent to one skilled in the art that sensors exist which can perform multiple measurements and the use of such multi-measurement sensors falls within the scope of the present invention. Those skilled in the art will also recognize that processor 10 could be a single processor or multiple processors and could be any processor 10 with sufficient processing power to formulate the desired drop size based on the sensors 20 employed. For example, processor 10 could be a microprocessor, a reduced instruction set computer (“RISC”), an application specific integrated circuit (“ASIC”) or combinations of different processor types.

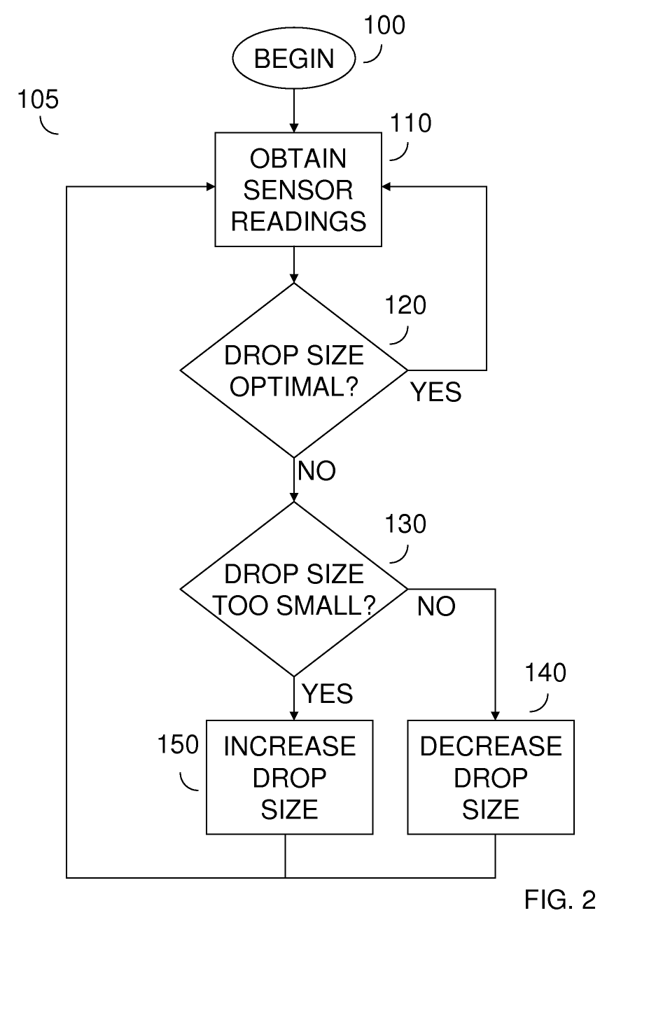

FIG. 2 is a flowchart 105 illustrating stages involved in determining and adjusting for an optimal drop size in accordance with various embodiments of the present invention. FIG. 2 shows an embodiment 105 in which the system is initialized at 100. It is considered within the scope of the present invention that initialization 100 could include a request for input from the operator of the device as to what type of optimal drop size is desired. For example, the operator could be given a choice of maximizing the drift, minimizing the drift or maintaining the drift within a specific range. At step 110 the various sensors begin to obtain information about the current conditions that will affect the drift of the spray. While the system may be configured to determine many factors that will affect the drift, it is conceivable and thus within the scope of the present invention that not all of the measurements will be employed in every determination of optimal drop size. While all of the measurements could be employed, for various reasons, it may be more efficient to only use a subset of the measurements to determine the optimal drop size. The choice to use only a subset of the measurements could be a design choice that is provided to the operator or it could be designed into the system based on certain conditions. For example, if certain measurements fall within a defined range, the system could be designed to ignore that/those measurements in the next calculation of optimal drop size, for a set period of time or it could be designed to ignore those/that measurement for the duration of the current spray. Once the sensor readings are obtained at step 110, the readings are supplied to the processor(s). At step 110, the processor(s), employing some or all of the obtained readings will determined an optimal drop size for the current conditions. Those skilled in the art will recognize that optimal drop size could be different for different operations. For example, optimal drop size could be determined to minimize drift in the case of harmful pesticides, or it could be determined to maximize or increase drift in the case of fertilizer or some other beneficial chemical that the operator wants to reach hard to reach areas.

At step 120 of FIG. 2, the processor(s) compares the optimal drop size to the current drop size. The equations required to calculate flow rate, drop size and drift are well known as are the tables that show spray volumes for various nozzles and thus will not be reproduced herein. In the event that the sprayer has not yet begun spraying, it is within the scope of the invention, that there could be a default value for the initial drop size, or the first calculation of optimal drop size at step 110 could be employed to set the initial drop size. If the sprayer is in operation, at step 120, the processor(s) compare(s) the calculated optimal drop size to the current drop size and determines if they are identical or within an acceptable range. If the current drop size is the same as or within the acceptable range as the optimal drop size, the system returns to step 110 and recalculates the optimal drop size based on the current sensor readings. Those skilled in the art will recognize that these sensor readings could be continuous or periodic. In a preferred embodiment, the calculations will be periodic as conditions will probably not fluctuate greatly on a continuous basis.

If the system at step 120 determines that the current drop size is not the same as or falls outside of an acceptable range, it determines at step 130 whether the drop size needs to be increased or decreased. To increase the size of the drop, the processor will send a signal to the nozzle control at step 150 to decrease the pressure of the spray thus increasing the size of the drop. Depending on the type of nozzle employed, this pressure drop can be achieved by decreasing air pressure, increasing or decreasing (depending on the location and purpose of the aperture) one or more apertures of the nozzle and/or increasing the volume of a chamber in the nozzle. Decreasing the air pressure is self explanatory. Increasing or decreasing an aperture can be achieved in any number of conventional ways. For example, servo motors, solenoids or the like may be employed to cause an object such as a conical shaped rod, a cylindrical rod or some other shaped rod to move in or out of the aperture or to place some other form of impediment across a portion of the aperture. Conversely, to decrease the size of the drop the processor will send a signal to the nozzle control at step 140 to increase the pressure of the spray thus decreasing the size of the drop. Depending on the type of nozzle employed, this pressure increase can be achieved by increasing air pressure, decreasing or increasing one or more apertures of the nozzle and/or decreasing the volume of a chamber in the nozzle. This can be achieved by using the methods described in connection with increasing the drop size in reverse. Once the drop size is adjusted, the system returns to step 110.

The previous examples illustrate various possible ways to adjust the drop size of a liquid in a spray based on existing conditions. Those skilled in the art will recognize that this is not an exhaustive list. Many examples exist that were not listed, which also fall within the scope of the invention.

Thus it is seen that systems and methods are provided for spraying chemicals and automatically adjusting, in substantially real-time, the drop size of the liquid in the spray. Although particular embodiments have been disclosed herein in detail, this has been done for purposes of illustration only, and is not intended to be limiting with respect to the scope of the claims, which follow. In particular, it is contemplated by the inventors that various substitutions, alterations, and modifications may be made without departing from the spirit and scope of the invention as defined by the claims. Other aspects, advantages, and modifications are considered to be within the scope of the following claims. The claims presented are representative of the inventions disclosed herein. Other, unclaimed inventions are also contemplated. The inventors reserve the right to pursue such inventions in later claims.

Insofar as embodiments of the invention described above are implemented, at least in part, using a computer system, it will be appreciated that a computer program for implementing at least part of the described methods and/or the described systems is envisaged as an aspect of the present invention. The computer system may be any suitable apparatus, system or device, electronic, optical, or a combination thereof. For example, the computer system may be a programmable data processing apparatus, a general purpose computer, a Digital Signal Processor, an optical computer or a microprocessor. The computer program may be embodied as source code and undergo compilation for implementation on a computer, or may be embodied as object code, for example.

It is also conceivable that some or all of the functionality ascribed to the computer program or computer system aforementioned may be implemented in hardware, for example by one or more application specific integrated circuits and/or optical elements. Suitably, the computer program can be stored on a carrier medium in computer usable form, which is also envisaged as an aspect of the present invention. For example, the carrier medium may be solid-state memory, optical or magneto-optical memory such as a readable and/or writable disk for example a compact disk (CD) or a digital versatile disk (DVD), or magnetic memory such as disk or tape, and the computer system can utilize the program to configure it for operation. The computer program may also be supplied from a remote source embodied in a carrier medium such as an electronic signal, including a radio frequency carrier wave or an optical carrier wave.

What is claimed is:

1. A system for dispersing a liquid and for automatically changing a drop size of the liquid being dispersed in substantially real-time, the system comprising:
a spraying device having at least one nozzle for dispersing liquid;
a nozzle control coupled to the nozzle; said nozzle control configured to alter a drop size of the liquid in response to receipt of a control signal;
a processor in electrical communication with said nozzle control, said processor being configured to provide said control signal; and,
a plurality of sensors in electrical communication with the processor, said sensors being configured to provide input to said processor;
wherein said processor is configured to create said control signal based on said input.

2. The system according to claim 1, wherein said plurality of sensors are selected from the group consisting of global positioning system (GPS), radar, humidity sensor, wind speed sensor, wind direction sensor, temperature sensor, flow speed sensor and vehicle speed sensor.

3. The system according to claim 1, wherein said spraying device is a boom sprayer.

4. The system according to claim 1, wherein said processor comprises a plurality of processors.

5. The system according to claim 1, wherein said nozzle control includes an air pressure regulator.

6. The system according to claim 1, wherein said nozzle control includes a servo motor.

7. The system according to claim 1, wherein said control signal is configured to adjust the drop size to a desired size.

8. The system according to claim 7, wherein said desired drop size is a range of drop sizes.

9. A system for dispersing a liquid and for automatically changing a drop size of the liquid being dispersed in substantially real-time, the system comprising:
spray means for dispersing liquid wherein said spray means includes a nozzle and said liquid is dispersed through said nozzle;
control means for controlling a drop size of the dispersed liquid in response to receipt of a control signal;
sensor means for measuring a plurality of atmospheric conditions; and,
processor means for processing said measured atmospheric conditions, determining a desired drop size based upon said measured atmospheric conditions; comparing said desired drop size to said drop size and creating said control signal to adjust the drop size to the desired drop size.

10. A method of dispersing a liquid and for automatically changing a drop size of the liquid being dispersed in substantially real-time, the method comprising:
measuring with a sensor at least one atmospheric condition;
based on said at least one measurement, calculating with a processor a desired drop size and comparing said calculated drop size with an actual drop size of a liquid being dispersed through a nozzle;
determining that said calculated drop size and said actual drop size differ;
creating a control signal with the processor in response to said determination that said drop sizes differ;
sending said control signal to a nozzle control; and,
said nozzle control adjusting the actual drop size to equal the desired drop size to create a new actual drop size.

11. The method according to claim 10 further comprising determining at least one physical condition of an area to be sprayed, wherein said desired drop size is based on said physical condition.

12. The method according to claim 10 wherein said nozzle control is configured to change an air pressure being applied to said liquid.

13. The method according to claim 10 wherein said nozzle control is configured to change an aperture size of said nozzle.

14. The method according to claim 10 wherein said nozzle control is configured to change a chamber size of said nozzle.

15. The method according to claim 10 further comprising periodically measuring said atmospheric condition, calculating a new desired drop size, comparing said new desired drop size with said new actual drop size, creating and sending a control signal and adjusting said new actual drop size to equal said new desired drop size.

16. The method according to claim 10 further comprising continuously measuring said atmospheric condition, calculating a new desired drop size, and comparing said new desired drop size with said new actual drop size.

17. The method according to claim 10 wherein said calculating said desired drop size comprises calculating a desired drop size range and said comparing comprises comparing said actual drop size to said desired range.

18. The method according to claim 17 wherein said control signal is only created if said actual drop size is outside of said desired drop size range.
